(19) United States
(12) Patent Application Publication
(10) Pub. No.: US 2006/0047656 A1
(43) Pub. Date: Mar. 2, 2006

(54) Code, system, and method for retrieving text material from a library of documents

(76) Inventors: Peter J. Dehlinger, Palo Alto, CA (US); Shao Chin, Felton, CA (US)

Correspondence Address: PERKINS COIE LLP, P.O. BOX 2168, MENLO PARK, CA, 94026, US

(21) Appl. No.: 11/217,655

(22) Filed: Aug. 31, 2005

Related U.S. Application Data
(60) Provisional application No. 60/606,549, filed on Sep. 1, 2004.

(51) Int. Cl. G06F 17/30

(52) U.S. Cl. 707/6

(57) ABSTRACT

Disclosed are a computer-readable code, system and method for retrieving one or more selected texts from a library of documents. The system processes a user-input search query representing the content of the text to be retrieved, and accesses a word index for the documents to identify those texts in the database having the highest word-match scores with the search query. The weights of words in the query may be adjusted to optimize the search.

This patent application claims priority to U.S. provisional patent application No. 60/606,549 filed on Sep. 1, 2004, which is incorporated herein in its entirety by reference.

### FIELD OF THE INVENTION

The present invention relates to a computer system, machine-readable code, and a computer-assisted method for retrieving text material from a library of documents. It also relates to a database tool for work-product retrieval

### BACKGROUND OF THE INVENTION

Much of the professional time of lawyers, scientists, scholars, academic researchers and professional business writers is devoted to generating written documents, for example, scientific papers, patent applications, legal opinion, agreements, business documents, scholarly works, reports, and manuals. Typically, in the construction of a new written document, the writer will draw on material from previously prepared documents for ideas and modes of expression related to the subject matter at hand. In preparing a legal agreement, for example, a lawyer may draw on previously prepared agreements for boiler-plate language, and those terms of the agreement that apply to the new agreement. In preparing a scientific paper, a scientist may rely on earlier papers to describe methods and protocols, background material, and even a discussion of the data. In short, the writer will synthesize new ideas, data, or other descriptive material with previously prepared passage to construct the new document.

In practice, the writer may attempt to find a paragraph or passage of interest from an earlier document by searching through his or her electronic files or by searching published documents available through a search service or through the internet. The amount of effort required to locate the earlier document, and then check the document to determine whether the passage of interest is present may take more time than composing a new paragraph or passage from scratch. It would therefore be useful to provide a document generating system that allows a writer to efficiently retrieve text material from a document. e.g., for incorporating the text material into a new document.

### SUMMARY OF THE INVENTION

The invention includes, in one aspect, a computer-assisted method for retrieving one or more selected texts from a library of documents. The method involves first processing a user-input search query composed of a sentence, sentence fragment or word list containing non-generic words representing the content of the text to be retrieved, then accessing a database containing (1) a word records table composed of (1a) non-generic words contained in the documents and (1b) for each word in the table, a list of identifiers of texts in the documents containing that word, and (2) a document text table containing texts in said documents and associated text identifiers. This step is carried out to identify those texts in the library having the highest word-match scores with the search query, based on pre-assigned word-match values for the non-generic words in the query.

There is then displayed to the user, (i) the non-generic words in the search query, and (ii) for each of these non-generic words, (iia) an occurrence value related to the occurrence of that word relative to other words in the query among texts, e.g., at least 5 texts, having the highest word-match scores with the search query, and (iib) user choices for adjusting the word-match values of each of the non-generic words in the search query, relative to other words in the query. After processing user choices made in response to the displayed information, the dictionary of word records is accessed again to identify texts in the database having the highest word-match scores based on the user-adjusted word-match values. The identified texts are retrieved from the database and displayed to the user.

The texts that are searched and displayed may be paragraphs from the documents in the library, and the text identifiers in the word-records table include document identifiers and paragraph identifiers for each document.

Where some of the texts in a document are document titles, the step of accessing the database may include specifying a document title and a length value which specifies a given length of document text following the title in a document, where the accessing is performed so as to identify those texts in the database having the highest word-match scores with the search query which are also within the specified document length following the specified document title. The length value may specify a given number of paragraphs following the specified title in a document.

The information displayed to the user after first word-records search step may further include the texts in the library having the highest word-match scores based on the pre-assigned word-match values for the non-generic words in the search query. The word-match values that are preassigned to the non-generic words in the search query may be the same, or substantially the same value. Alternatively, the preassigned value may be related to previous user choices. The user choices displayed after the initial word-records search may be (1) discard, (2) leave unchanged, (3) emphasis and (4) require, where each choice is associated with an assigned word-weight value that reflects a new weight for that word.

Where the search query is represented as a description in natural-language passage, the query may be processed by classifying words in the summary description as either (i) generic, (ii) verb-root, or (iii) remaining words that are neither (i) nor (ii), discarding generic words, and converting verb-root words to a common verb root, where the verb-root words in the word-records database may be expressed in verb-root form.

In another aspect, the invention includes an automated system for retrieving one or more selected texts from a library of documents. The system includes (a) a computer, (b) accessible by said computer, a database containing (1) a word records table composed of (1a) non-generic words contained in the library documents and (1b) for each word in the table, a list of identifiers of texts in the documents containing that word, and (2) a document text table containing texts in the library documents and associated text identifiers, and (c) a computer readable code which is operable, under the control of said computer, to perform the method steps described above.

In a related aspect, the invention includes computer-readable code for use with an electronic computer and a database containing (1) a word records table composed of (1a) non-generic words contained in the library documents and (1b) for each word in the table, a list of identifiers of texts in the documents containing that word, and (2) a document text table containing texts in the documents and associated text identifiers. The code is operable, under the control of the computer, and by accessing said database and dictionary, to perform the steps of claim 1.

In still another aspect, the invention includes a computer-assisted method for retrieving one or more selected texts from a library of documents. The method involves, first, processing a user-input search query composed of a sentence, sentence fragment or word list containing non-generic words representing the content of the text to be retrieved, and a specified document title and length value which specifies a given length of text following said title in a document. There is then accessed a database containing (1) a word records table composed of (1a) non-generic words contained in the library documents and (1b) for each word in the table, a list of identifiers of texts in the documents containing that word, and (2) a document text table containing texts in the library documents and associated text identifiers, to identify those texts in the library having the highest word-match scores with the search query, based on pre-assigned word-match values for the non-generic words in the query, and which are within the specified length value following the specified title in the documents. The texts so identified are displayed to the user.

The specified length value may indicate a given number of paragraphs following the specified title in a document.

In still another aspect the invention includes a database system for work-product retrieval. The system is designed to store archived documents in database form, mine the database for information, and provide access to the documents, and to the mined information, for system users.

These and other objects and features of the invention will become more fully apparent when the following detailed description of the invention is read in conjunction with the accompanying drawings.

### BRIEF DESCRIPTION OF THE DRAWINGS

FIG. 1 shows the components for document management and retrieval in the system of the invention;

FIG. 2 illustrates the construction of the doc-type and library databases in practicing the invention;

FIG. 3 shows, in flow diagram form, operations of the system for processing a document into database form in the invention;

FIG. 4 is a flow diagram of steps for processing a document into a text-information table in a database;

FIG. 5 is a flow diagram of steps for processing text in a document to produce processed text;

FIG. 6 is a flow diagram of steps for processing a document into a word-records table in a database;

FIGS. 7A and 7B are flow diagrams of operations carried out by the library search module of the invention in retrieving desired text material from each document in a library of documents, in accordance with one aspect of the invention (7A), or from a section of each document in the library (7B);

FIG. 8 is a flow diagram of operations carried out in ranking a text by word match score;

FIG. 9 shows steps in a refined search to retrieve stored text material, in accordance with one aspect of the invention;

FIG. 10 illustrates steps in a data mining operation of the system in creating a citation-information database table;

FIG. 11 illustrates steps in a data mining operation of the system in creating a word-records database able from the citation-information database table of FIG. 10;

FIG. 12 shows the operation of the document-type search module in the system in searching for a citation of interest;

FIG. 13 shows the operation of the document-type search module in the system in searching for user expertise;

FIG. 14 shows the operation of the document-type search module in the system in searching for a document paragraph of interest; and

FIG. 15 shows the operation of the document-type search module in the system in searching for a document of interest.

### DETAILED DESCRIPTION OF THE INVENTION

A. Definitions

The term “text” will typically intend a plurality of sentences, and typically will indicate a single paragraph contained in a written work, but may also include a portion of a paragraph, multiple adjacent paragraphs, or an entire document.

A “paragraph” refers to its usual meaning of a distinct portion of written or printed material dealing with a particular idea or thought, usually beginning with an indentation, and including one or more separate sentences.

A “passage” refers to one or more paragraphs, usually connected in idea or thought, and usually part of a series of consecutive paragraphs in a written document.

A “document” refers to a self-contained, written or printed work, such as an article, patent, agreement, legal brief, book, treatise or explanatory material, such as a brochure or guide, being composed of plural paragraphs or passages.

A “section” or “category” of a document refers to a portion of a document dealing with one of the two or more subdivision of the document. As examples, a patent will include separate categories for background, examples, claims and detailed description. A scientific paper will contain separate categories for background, methods, results and discussion. A legal agreement will contain separate categories for definitions, grant, monetary obligations, termination, and so forth. A scholarly treatise may contain separate categories for introduction, methodology, results, and conclusions. Each category is typically composed of multiple paragraphs, although shorter sections, such as background or introduction may be composed of a single paragraph. In some cases, a category may refer to one or more documents have been assigned to a common class or name.

A “search query” refers to a single sentence or sentences a sentence fragment or fragments or list of words and/or word groups that are descriptive of the content of the text being searched.

“Processed text” refers to text information resulting from the processing of a digitally-encoded text (preprocessed text) to generate one or more of (i) non-generic words, (ii) strings of non-generic words, (iii) word strings wordpairs formed of proximately arranged non-generic words, (iv) text identifiers, including document, paragraph, section, and user identifiers.

A “verb-root” word is a word or phrase that has a verb root. Thus, the word “light” or “lights” (the noun), “light” (the adjective), “lightly” (the adverb) and various forms of “light” (the verb), such as light, lighted, lighting, lit, lights, to light, has been lighted, etc., are all verb-root words with the same verb root form “light,” where the verb root form selected is typically the present-tense singular (infinitive) form of the verb.

“Generic words” refers to words in a natural-language passage that are not descriptive of, or only non-specifically descriptive of, the subject matter of the passage. Examples include prepositions, conjunctions, pronouns, as well as certain nouns, verbs, adverbs, and adjectives that occur frequently in passages from many different fields. “Non-generic words” are those words in a passage remaining after generic words are removed.

A “word group” is a group, typically a word pair, of non-generic words that are proximately arranged in a natural-language passage. Typically, words in a word group are non-generic words in the same sentence. More typically they are nearest or next-nearest non-generic words in a string of non-generic words, e.g., a word string.

Words and optionally, words groups, usually encompassing non-generic words and wordpairs generated from proximately arranged non-generic words, are also referred to herein as “terms”.

A “document identifier” or “DID” identifies a particular digitally encoded or processed document in a database, such as patent number, or document-archive number.

A passage or paragraph identifier (PID) identifies a particular paragraph within a document.

A “text identifier” or “TID” uniquely identifies a particular passage, typically a particular paragraph, within a group of documents. The passage identifier typically includes separate document and paragraph identifiers (DID, PID) for each passage in each document, or may include a single unique identifiers for each passage in the collection of documents.

A “word-position identifier” of “WPID” identifies the position of a word in a passage. The identifier may include a “sentence identifier” which identifies the sentence number within a passage containing a given word or word group, and a “word identifier” which identifiers the word number, preferably determined from distilled passage, within a given sentence. For example, a WPID of 2-6 indicates word position 6 in sentence 2. Alternatively, the words in a passage, preferably in a distilled passage, may be number consecutively without regard to punctuation.

A “database” refers to a database of records or tables containing information about documents. A database typically includes two or more tables, each containing locators by which information in one table can be used to access information in another table or tables.

B. System Components

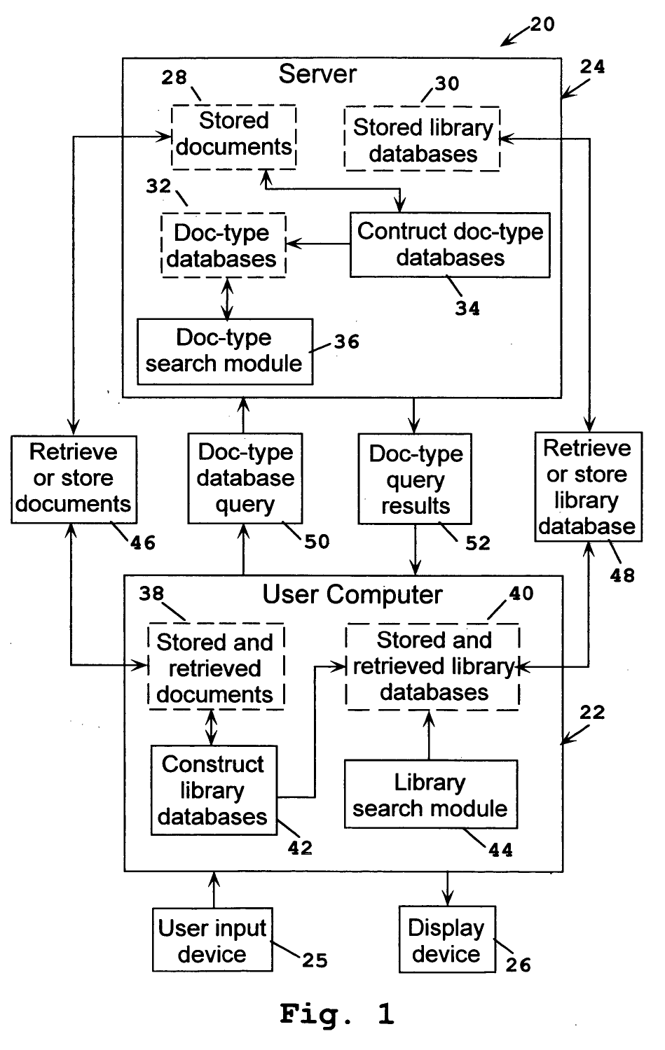

FIG. 1 shows the basic components of a system 20 for managing and distributing information, e.g., documents, document passages, citations, and user information that can be embedded in stored documents. In general, the system includes a plurality of user computers, such as computer 22 which are connected together for document exchange, typically through a central server 24, according to a standard networked computer system. Each user computer has a user input device 25, such as a keyboard, modem, and/or disc reader, by which the user can enter search-query information and refine search results, as will be seen below. A display device 26, e.g., monitor, displays the search interfaces described below, and allows user input and feedback, and system output.

In a typical system, the server includes stored documents 28 that are archived by individual users from their user computers. Also stored on the server are stored library databases 30. A database tool 34 which operates on the server accesses stored documents to construct document-type (doc-type) databases 32, and these databases can be searched, from the individual computers, by a doc-type search module 36 on the server. One exemplary database tool is MySQL database tool, which can be accessed at www.mysql.com.

Also in a typical system, user computer 22 includes stored and retrieved documents 38 which can be stored to or retrieved from the server by a standard network operation 46 for document exchange, and stored and retrieved library databases 40 which can be which stored to or retrieved from the server by a standard network operation 48 for document exchange. A database tool 42 which operates on the user computer accesses stored documents to construct library databases 40, and these databases can be searched, from the individual computers, by a library search module 44 on each user computer. One exemplary database tool is MySQL database, which can be accessed at www.mysql.com.

It will be appreciated that the assignment of various stored documents, databases, database tools and search modules, all of which will be detailed below, to a user computer or a central server or central processing station is made on the basis of computer storage capacity and speed of operations, but may be modified without altering the basic functions and operations to be described. For example, in a system with relatively modest storage capacity requirements, each user computer may carry out all of the storage and operational functions shown for both the user computer and central server, with each computer in the network being capable of document and library exchange with other user computers. Similarly, the central server in the system may carry out all of the database construction and search operations in the system, upon instruction from a user computer.

C. Database Text Structures

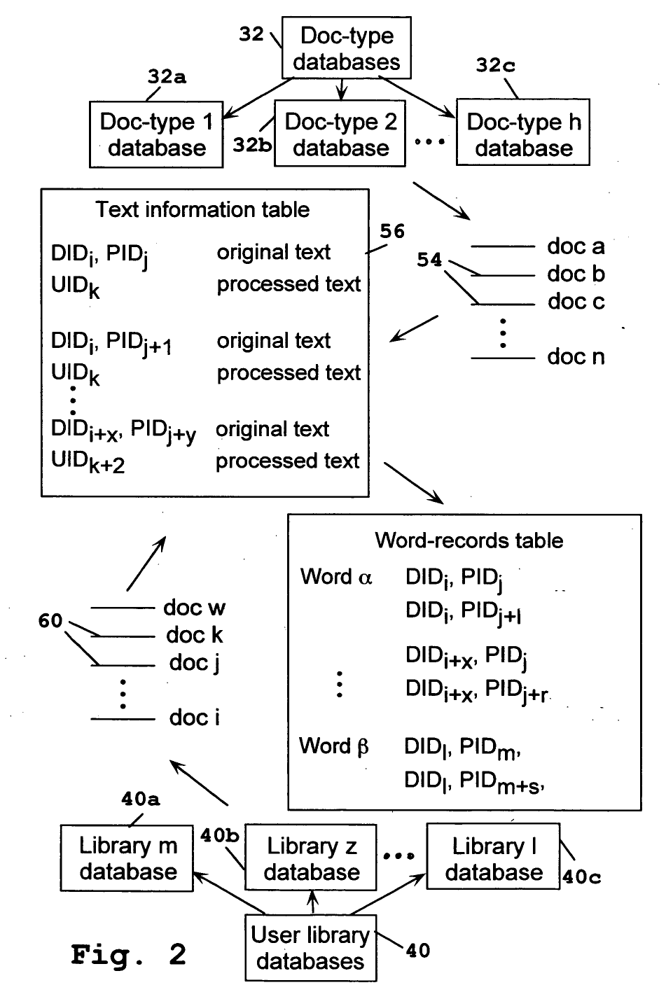

The system of the invention has four database text structures whose relationships will be described with respect to FIG. 2. These are document types (doc types), libraries, documents, and paragraphs. Documents are what the user creates, stores, and retrieves, and typically are composed of individual paragraphs, often large numbers of paragraphs. Paragraphs are the text units retrieved in many of the search operations, as described below. Doc types and libraries are databases made up of text and identifier information from one-to-many individual stored documents.

Doc type is defined by the type of document stored in a doc-type database, and/or by a topic within the general arena in which the system is designed to operate. For example, in the arena of law, there may be separate doc types for each major field of law or practice area within a law firm, e.g., intellectual property, business law, litigation, real estate, and so forth, and for each such field, a separate doc type for each type of document in that area, e.g., patent applications, amendments, appellate briefs, opinions, and license agreements in the field of intellectual property. As another example, when used as a tool for managing and distributing expertise within an R&D group, each different field of research and each type of document within that field, e.g., grant proposals, reports, and journal articles or pre-prints, may have a separate doc type.

A doc type is the “unit” that is searched by users for specific stored documents or for information that may be mined from such documents. As such, an important purpose of doc-type classification is to divide the total collection of documents within a group, e.g., large law firm or research organization, into logical storage and search units that are readily recognized by users for purposes of archiving and searching documents.

With reference to FIG. 2, the system itself may include only a few or up to 100 of more different doc-type databases 32, such as databases 32a, 32b, 32c, where each doc-type database, such as database 32b, will be processed typically from 50-1,000 documents, such as documents 54, indicated by doc a, doc b, doc c, and doc m in 54 (although there are no upper or lower bounds on numbers of documents in a single doc type.) A doc-type database, such as database 32b, includes a text-information table 56 and a word-record table 58. The text-information table includes, for each paragraph of each documents making up the database, a document ID (DID), a paragraph ID (PID), user ID (UID, meaning the identity of creator of the document), the original text of that paragraph, and the processed text of the paragraph. As noted above, the combination of a DID and PID define a unique text ID (TID) within the database. As will be seen below, the processed text is used by the database tool in generating the word-records table in the database. Information in this table, e.g., original text, is accessed typically by TID (DID and PID) locators.

The word-records table includes, for each non-generic word (the key locator) contained in any of the documents of the database, the DIDs, and corresponding PIDs and UID for all document and paragraphs containing that word.

A second basic type of database in the system is a user library database, such as the databases 40 indicated at 40a, 40b, and 40c in FIG. 2. Each library database, such as library 40b, is constructed from a collection of documents, such as documents 60 shown as doc i, doc j, doc k, and doc w in the figures. A typical library will have 1-20 documents, and in most cases, many fewer documents than forming a doc-type. The library database has both text-information and word-records tables, such as tables 56 and 58 whose general structures are described above.

D. Constructing Doc-Type and Library Databases

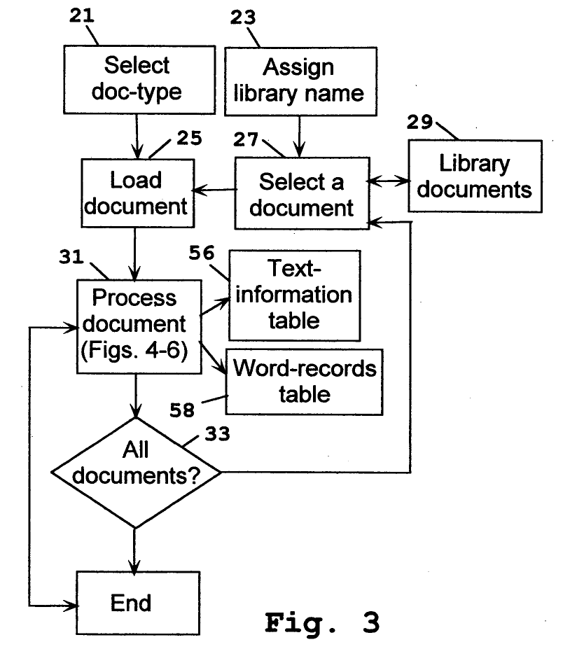

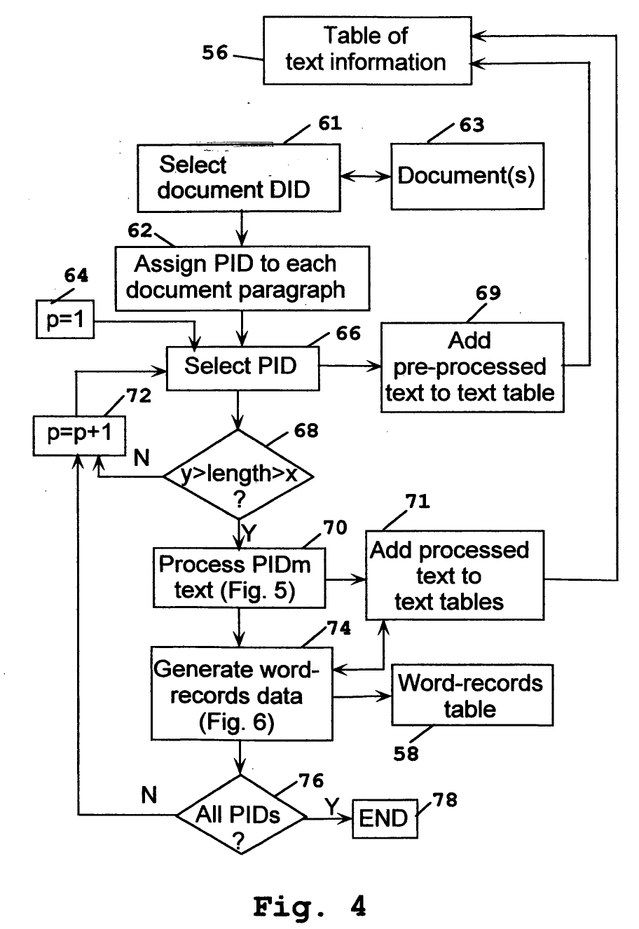

FIG. 3 illustrates basic steps in forming doc-type and libraries databases in the system of the invention. When a user is archiving a completed document for inclusion into a given doc-type database, the first step is to select the appropriate doc-type for that document, as indicating at 21. This may be done conveniently by including in the archiving interface, a doc-type list that the user can address conventionally to find the most pertinent doc type, knowing the field and type of document to be archived. The user then loads the document in the selected doc-type, at 25, and from here, the document is processed at 31, as will be detailed further in FIGS. 4-6) to add to existing text-information and word-records tables 56, 58, respectively. The procedure ends at 35 with the loading of each single document.

When forming a new library database, the user first assigns a library name, at 23, and selects at 27 a document from a collection of documents 29 that will form the library. The document is then loaded, at 31, and processed to create a new database for the first document in the library. Thereafter, each additional document is loaded, through the logic of 33, and processed and added to the existing library database. The process is complete, at 35, when all of the library documents have been so processed.

FIGS. 4-6 illustrate steps in the processing of a newly-loaded document to form a new doc-type or library database, or in adding a document to an existing library. Initially, when creating a new database, an empty table of text information, shown at 56 is created. When adding a document to an existing database, table 56 will already include text information from previously loaded documents.

The one or more documents to be loaded into a database are indicated at 63. Typically, a single document is added to a doc-type database at any time, while several documents may be loaded to form a library database. A document selected from 63 is assigned a document ID (DID) at 61 and each paragraph in that document is then assigned a successive paragraph IDs (PIDs). As indicated above, each pair of DID and PID represents a text ID (TID) that uniquely identifies that paragraph within a database. In addition, each paragraph is assigned a user ID (UID) which identifies the creator or originator of the document.

Once the paragraphs in the document have been assigned DID, PID, and UID values, each paragraph in the document is processed successively, beginning with paragraph 1 in the first document, as indicated at 64, 66. The actual passage (preprocessed or unprocessed passage) is added to table 56, along with its paragraph identifiers, as indicated at 69. The next step is to determine whether the passage has the right length for processing. There are two length constraints to consider. First, if the paragraph is less than y words in lengths, e.g., 4-6 words in length, it probably represents a section title or heading within the document. This “paragraph” will then be processed as a section heading. Second, if the paragraph is greater than x words in length, e.g., 15-25 words, it probably represents a paragraph with meaningful text. The assumption here is that paragraphs having a length greater than x, but less than y, e.g., paragraphs of 6-20 words, are neither section headings or meaningful text, but probably represent miscellaneous text, such as figure or table descriptions, formulae, or subheadings.

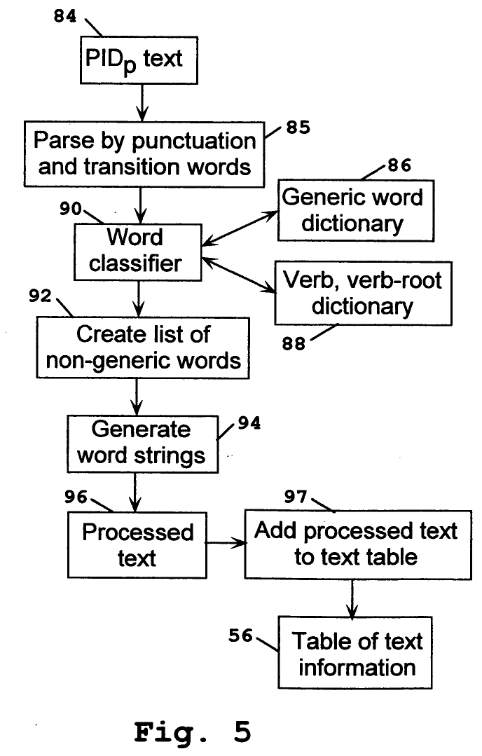

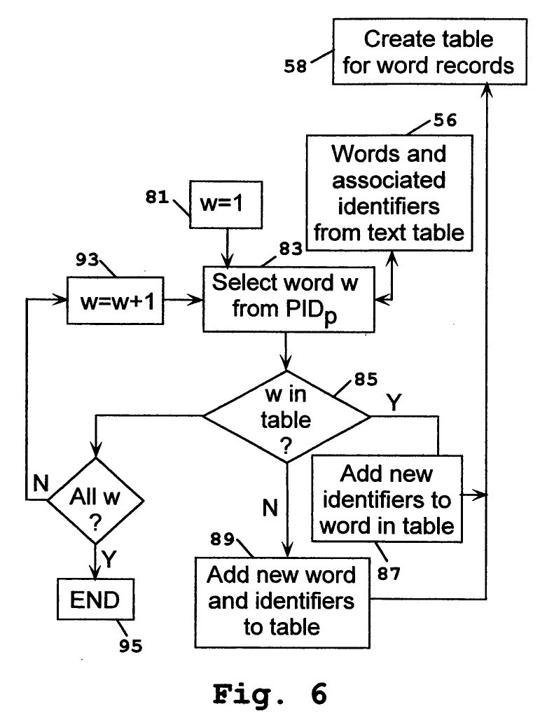

If the paragraph length (including all generic and non-generic words) fails to meet the length condition in logic diamond 68, it is not processed further and the program proceeds to the next program, at 72. If the length condition is met, If the paragraph length (counting all generic and non-generic words) meets the condition y>length>x, the paragraph is further processed at 70 and as detailed in FIG. 5, and the processed text is added to text-information table 56, as indicated at 71. The processed text is then used in generated word-records data, as indicated at 74 and discussed below with reference to FIG. 6, for constructing the word-records table 58. Once all PIDs for a given document have been considered, through the logic of 76, 72, the program either ends, at 78, or proceeds to process the next document to be loaded.

FIG. 5 illustrates the steps in the processing of a selected paragraph of a template document. The text of the selected paragraph at 84 represents a paragraph m from the document loading operation shown in FIG. 4. The first step in the processing module of the program is to “read” the paragraph for punctuation and other syntactic clues that can be used to parse the passage into smaller units, e.g., single sentences, phrases, and more generally, word strings. These steps are represented by parsing function 85 in the module. The design of and steps for the parsing function are described more fully in co-owned published PCT patent application for “Text-Representation, Text Matching, and Text Classification Code, System, and Method,” having International PCT Publication Number WO 2004/006124 A2, published on Jan. 14, 2004, which is incorporated herein by reference in its entirety and referred to below as “co-owned PCT application.”

If the document being loaded is a text document taken from a website or search database, and the end of each sentence is followed by a carriage return, the program also removes single carriage return commands from the document (such documents tend to include two carriage returns between paragraphs, so a code between paragraphs is still preserved).

After the initial parsing, the program carries out word classification functions, indicated at 90, which operates to classify the words in the passage into one of three groups: (i) generic words, (ii) verb and verb-root words, and (iii) remaining groups, i.e., words other than those in groups (i) or (ii), the latter group being heavily represented by non-generic nouns and adjectives.

Generic words are identified from a dictionary 86 of generic words, which include articles, prepositions, conjunctions, and pronouns as well as many noun or verb words that are so generic as to have little or no meaning in terms of describing a particular invention, idea, or event. For example, in the patent or engineering field, the words “device,” “method,” “apparatus,” “member,” “system,” “means,” “identify,” “correspond,” or “produce” would be considered generic, since the words could apply to inventions or ideas in virtually any field. In operation, the program tests each word in the passage against those in dictionary 86, removing those generic words found in the database.

A verb-root word is similarly identified from a dictionary 88 of verbs and verb-root words. This dictionary contains, for each different verb, the various forms in which that verb may appear, e.g., present tense singular and plural, past tense singular and plural, past participle, infinitive, gerund, adverb, and noun, adjectival or adverbial forms of verb-root words, such as announcement (announce), intention (intend), operation (operate), operable (operate), and the like. With this database, every form of a word having a verb root can be identified and associated with the main root, for example, the infinitive form (present tense singular) of the verb. The verb-root words included in the dictionary are readily assembled from the passages in a library of passages, or from common lists of verbs, building up the list of verb roots with additional passages until substantially all verb-root words have been identified. The size of the verb dictionary for technical abstracts will typically be between 500-1,500 words, depending on the verb frequency that is selected for inclusion in the dictionary. Once assembled, the verb dictionary may be culled to remove generic verb words, so that words in a passage are classified either as generic or verb-root, but not both.

If a verb-root word is found, the word is converted to its verb root, so that all words related to the same verb-root word become equivalent for search purposes. Once this is done, the program generates at 92 a list of all non-generic words, including words that have been converted to their verb root.

The parsing and word classification operations above produce distilled sentences or word strings, as at 94, corresponding to paragraph sentences from which generic words have been removed. The distilled sentences may include parsing codes that indicate how the distilled sentences will be further parsed into smaller word strings, based on preposition or other generic-word clues used in the original operation, as described in the above co-owned PCT patent application. The words in the distilled sentences or word strings may be assigned word-position identifiers (WPIDs) that indicate the word position of each non-generic word in the processed paragraph. The distilled sentences of the paragraph are then placed in the table of text information as processed text corresponding to the identified document and paragraph identifiers. The resulting text-information table is as described above with respect to FIG. 2.

The program uses word data from the processed passages in the template-documents database to generate word-records table 58, as illustrated by the program steps shown in FIG. 6. This table is essentially a dictionary of non-generic words, where each word has associated with it, each TID (DID and PID pair) containing that word, and optionally, sentence identifiers (SIDs) and/or word position identifiers (WPIDs) associated with the given word in that paragraph.

In forming the word-records file, and with reference to FIG. 6, the program creates an empty ordered table 58, and initializes the TID to 1, representing the first paragraph (passage) in the first template document. For a given TID being processed, the program initializes the paragraph word count to 1, at 81, and selects this word and the identifiers associated with that paragraph from the processed text for that paragraph in the table of text information, as shown at 83.

During the operation of the program, a table of word records 58 begins to fill with word records, as each new paragraph is processed. This is done, for each selected word w in a paragraph, by accessing the word records table, and asking: is the word already in the table (box 85). If it is, the word record identifiers for word w in the paragraph are added to the existing word record, at 87. If not, the program creates a new word record with identifiers from the passage at 890. In an exemplary embodiment, every verb-root word in a template-document passage is converted to its verb root; that is, all verb-root variants of a verb root word are converted to a common verb root. This process is repeated until all words in the selected paragraph have been processed through to the logic of 91, 93, then repeated for each new paragraph in table 56, that is each processed text which has not already been added to the word-records table.

When all passages, e.g., paragraphs in the template documents database have been so processed, the table contains a separate word record for each non-generic word found in at least one of the paragraphs of all of the documents in the database, where each word record includes a list of all TIDs, and, for each TID, the UID and optionally, WPIDs associated with that word in that paragraph. The resulting word-records table is as described above with respect to FIG. 2.

Of course the word-records table may organize words (the key locator) and text information in a variety of ways other than that just described. For example, instead of placing all word-identifier information under a single word, the table could simple add the same word to a table multiple times, each word entry representing the word and associated text information for that word in that text identifier. Also, a “word-records table” for all words in the stored documents may be a single table or made up of many tables, e.g., 26 separate table for words beginning with each letter of the alphabet.

It will further be appreciated that these table are exemplary only of database tables that would be suitable in the invention. For example, the system may include an additional documents table that includes a document name as key locator, and for each document, user identifier, and date identifiers, such as date of document creation and date of document archiving, as well as text identifiers, such as number of paragraphs or total word length. With this “documents” table, general information about a document can be retrieved much faster than by querying each entry in a text-information or word-records table.

E. Library Search Operations

This section considers the operation of the system in searching and retrieving document paragraphs from a collection of stored documents, i.e., a document library, in database form. Certain of the operations described here will also be used in operations used in doc-type search and retrieve operations, as will be described below.

The purpose of library searching is to locate text material interest that can be recycled into a new document under preparation, or to locate specific types of information contained in one or more of the library documents. The library from which the text material is derived typically contains from 2-20 a few to several, e.g., 2-15 documents that collectively would be expected to contain text material useful in preparing the new document. For example, in use in preparing a license agreement, the library might contain a number of different agreements, each with somewhat different terms and objectives. At each stage in the preparation of the agreement, the user would hope to find paragraphs from at least one agreement document that can be transposed into the new document, and modified as necessary.

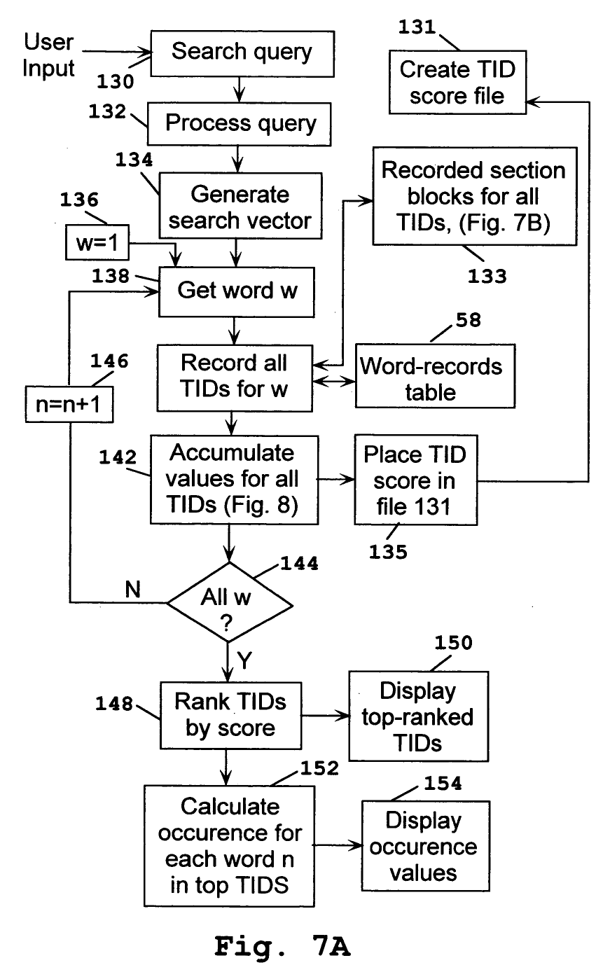

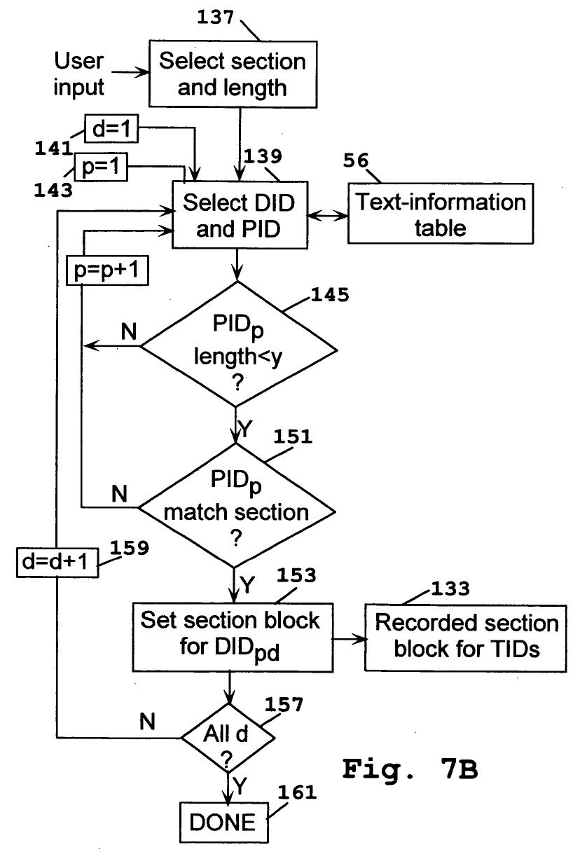

FIG. 7A is a flow diagram of steps in the search and retrieve operation. Initially, the user enters a search query, at 130. The input may be a short summary, in sentence or sentence-fragment format, of the idea or concept to be searched, or may be simply a list of words that represent the concept. The program processes this query at 132, generating a search vector at 134. The search vector is composed of word and optionally word-pair terms extracted from the query, and for each term, a coefficient that indicates the weight that term is to be given, relative to other terms in the vector. In one embodiment, the vector terms are simply all of the non-generic words contained in the search query, with each word being assigned a coefficient value of 1. In this embodiment, the program simply reads the search query, extracts non-generic words (see above), converts verb words to verb-root words, and assigns each term a coefficient of 1.

If a more refined search is desired, the program may operate to extract both non-generic words and proximately formed word pairs in constructing the search vector, and assign to these terms either the same coefficient, e.g., 1, or a coefficient related to the term's selectivity value and IDF (in the case of word terms), as described in the above co-owned PCT patent application. Where term selectivity values are used in constructing the search vector, the system will include a word-records table (not shown) composed of words from two different libraries of passages.

Although not shown here, the vector may be modified to include synonyms for one or more “base” words in the vector. These synonyms may be drawn, for example, from a dictionary of verb and verb-root synonyms such as discussed above. Here the vector coefficients are unchanged, but one or more of the base word terms may contain multiple words, again as described in the above co-owned PCT patent application.

The program then selects the first word w in the query, shown at 136, 138, and accesses the library word-records table 58 to find all TIDs (DID and PID pairs) containing that word. If the user has placed a “section” constraint on the search, as discussed below in connection with FIG. 7B and indicated at 133, the program records only those PIDs within the specified section constraint. If no section constraint is imposed, all PIDs from each library document will be considered.

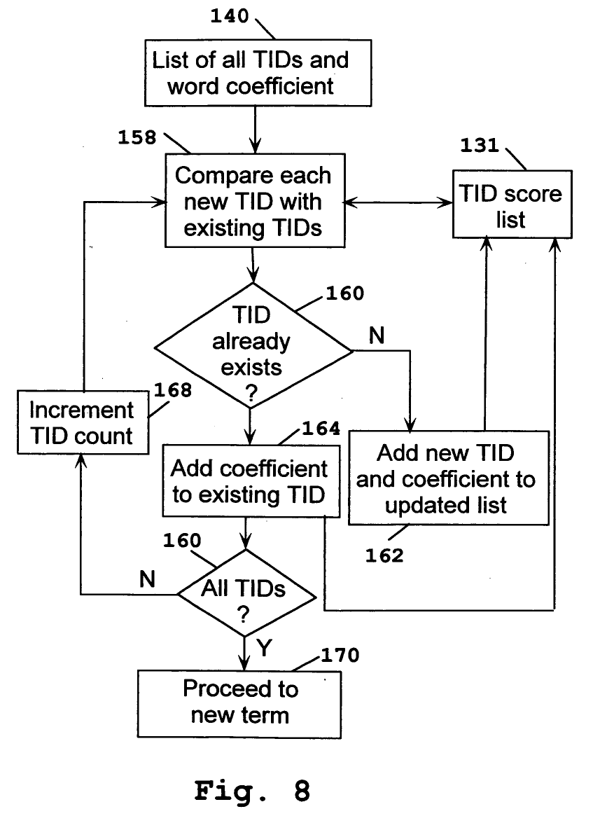

Once the PIDs for a given word w are recorded, the program accumulates the values for all PIDs considered, at 142, in accordance with the algorithm described below with respect to FIG. 8. This is done by placing the TID scores for that word in a TID score file 131, as indicated at 135. The TID score placed in the file for each TID will typically be the coefficient for word w, e.g. the value 1. Thus, for each word, all PIDs containing that word (that are within the user's specified section constraint) are recorded as a coefficient value. The operation then proceeds to the next word w in the query, through the logic of 144, 146, and repeats the same scoring operations for each word, until all words (and optionally, word pairs) in the query have been considered.

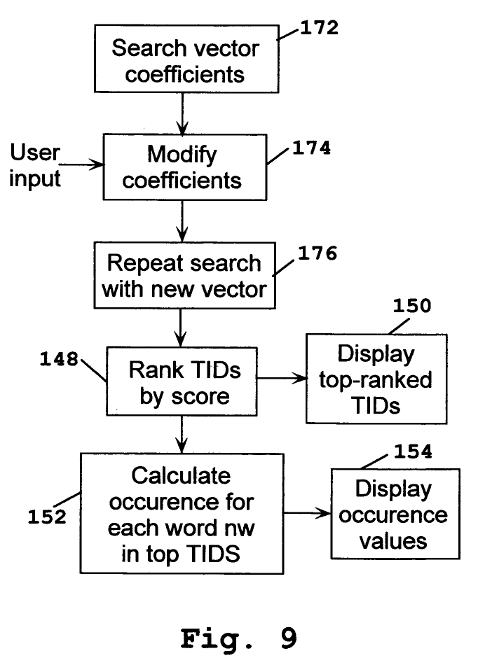

When all of the non-generic words in the query have been considered, the query-match score for each TID in the search field is calculated, e.g., from the sum of the coefficients for that paragraph. The TID are then ranked by scores, as at 148, and the top-ranked TIDs may be displayed to the user at 150. The program also calculates the occurrence of each query word in the top n ranked TIDs, e.g., the top 10 or 20 TIDs, at 152 and the occurrence values are also displayed to the user at 154. The occurrence values are employed in evaluating and modifying the search, as described below with respect to FIG. 9.

One feature of the system is the ability to limit the search in a library database to a particular section within the documents of the library. This is done by specifying a document title or title word that is common (or likely to be common) to all of the documents making up the library. For example, in a library of patents or patent applications, document title containing the words “background,” “description invention,” example,” and “claim,” are likely to be common to all of the documents. (The program automatically considers different verb forms of the word and plurals, e.g., “claimed” and “claims” for “claim.”

In addition to a document tile, the user specifies a number of paragraphs following that title that define the size of the section that is searched. For example, if the section tile is “background,” and the specified section size is 15 paragraphs, the search will consider the 15 paragraphs immediately following the title “background. Of course, all documents may have a different section length, so some paragraphs beyond the “background” section may be considered in some documents, and in some cases, not all of the paragraphs in a section may be considered. It will be appreciated, however, that this approach allows a user to focus a search for text material among documents largely on the paragraphs within a given document section.

The operation of the system in defining the section and size constraint for the search is shown in FIG. 7B. At 137 is the user-selected section title (that is, word or words in the document section titles for that section) and section length, given in number of paragraphs following the title. The program initialize the library document DID and document paragraph PID to 1, at 141, 143, respectively, and selects the first paragraph in the first document from text-information table 56, at 139. If the selected paragraph has a length less than y, e.g., less than six total words, it is read as a tile, at 145; otherwise, the program proceeds to the next paragraph in the document, at 147, and this process is repeated until the first title (less than y words total) is found.

The program now looks for a match between the user-specific title word(s) and the document title heading, at 151. A match is found if and only if (i) for a single specified word, that word is in the title heading, and (ii) if more than one word is specified, all of the specified words are in the title. If not match is found, the program proceeds, through the logic of 151, 147, and 145 to the next title. If a match is found, the program sets the section block to be searched in that document. This is done (block 153), by noting the PID of the section paragraph, and defining the section in that document as the X (user-specified section length) PIDs following the section-heading PID. The assigned paragraphs to be search in that document, corresponding to the X paragraphs following the specified section tile are recorded at 133. This process is repeated for each document in the library, through the logic of 157, 159, until paragraph numbers corresponding to the specified section and length have been identified for each document in the library, with the operation terminating at 161.

As noted above, when a section title and length are specified, the search operation records and accumulates values (140, 142 in FIG. 7A), only for those paragraphs that have been identified at 133 as being within the user-specified section constraint.

FIG. 8 illustrates the operation of the system in accumulating TIDs scores during a search operation (box 142 in FIG. 7A). Box 140 in FIG. 7A and FIG. 8 contains the accumulating record of TIDs for words w in the search query. As each new additional TID for a word w, it is compared with all TIDs then recorded, at 158. If the TID matches one already recorded, the coefficient of that TID and word w is placed, at 164, in the TID score list 131. That TID now contains the coefficient values for at least two words w in the query. If the recorded TID is not already in list 131, that TID is added, at 162, to list 131 as a new TID, which now contains a single coefficient value. This process is repeated, through the logic of 160, 168 for all TIDs recorded for a given word w in the query. Once complete, the program proceeds, at 170, to the next query term.

Once the initial search is completed, the results are displayed to the user at 150, for example, as a group of paragraphs that the user can scroll through to view each of the template paragraphs. The displayed paragraphs are preprocessed passages retrieved from the text-information table, according to TID.

FIG. 9 illustrates various steps and operations carried out by the system that allow the user to evaluate and refine a search. As noted above, the initial display includes a word-occurrence display that indicates the number of times each non-generic word in the query appears in one of the n, e.g., 20, top-ranked paragraphs, where the search employed initial coefficients, typically each word being assigned a coefficient value of 1, as indicated at 172. Based on the displayed word occurrences, the user may wish refine the search, by modifying the search coefficients at 174, to either emphasize or de-emphasize certain vector terms. In the user interface presented in Section F below, this is done by displaying to the user the occurrence of each non-generic word in the search vector in the top-ranked paragraphs, and also providing for each term, user selections for modifying the relative weights (coefficient value) assigned to that word. In the embodiment shown the user can either discard the word from the search, by unclicking the word box, retain the same word value (default) enhance the word value by 5 (emphasize) or enhance the word value by 100 (require). The search is then repeated at 176 and 148, with the new search-vector coefficients, and the new results displayed to the user at 150. The program also calculates the new word occurrences, at 152, and displays these at 154.

When the user selects a top-ranked template paragraph, at 150, the user interface also allows the user to view adjacent paragraphs that precede or follow the selected paragraph in that template document. Using this feature, the user may select a number of related consecutive paragraphs, e.g., an entire passage, for importation into the target document. This feature also gives the user access to short document paragraph that were not processed, but are stored as processed passage in the template documents database. Assuming one or more suitable paragraphs are found, these are copied from the user interface for pasting into the target document. Alternatively, the system may be designed for automated transfer of the selected paragraph(s) into a word-processing document.

F. Data Mining and Citation-Name Databases

Data mining refers to the non-trivial extraction of implicit, previously unknown, interesting, and potentially useful information from data. The extracted data may be used to describe a hidden regularity of data, to make predictions, or to aid in decision making.

The present system mines document-type databases for citation data, referring to legal or bibliographic citations to case law or literature references or other published references. For purposes of illustration, this section will describe various ways that legal case-law citations are mined and used; however, it will be understood that the same techniques and applications could be applied to other types of citations. The mined citation data may be stored in the form of additional tables in a document-type database that relates citations, legal propositions, and users (creators of documents).

The citations may be employed in the system as a shorthand for certain propositions or statements, e.g., legal propositions, and as such can be used for identifying documents associated with specified combinations of propositions, and for identifying users (creators of documents) who have certain expertise with problems associated with those citations.

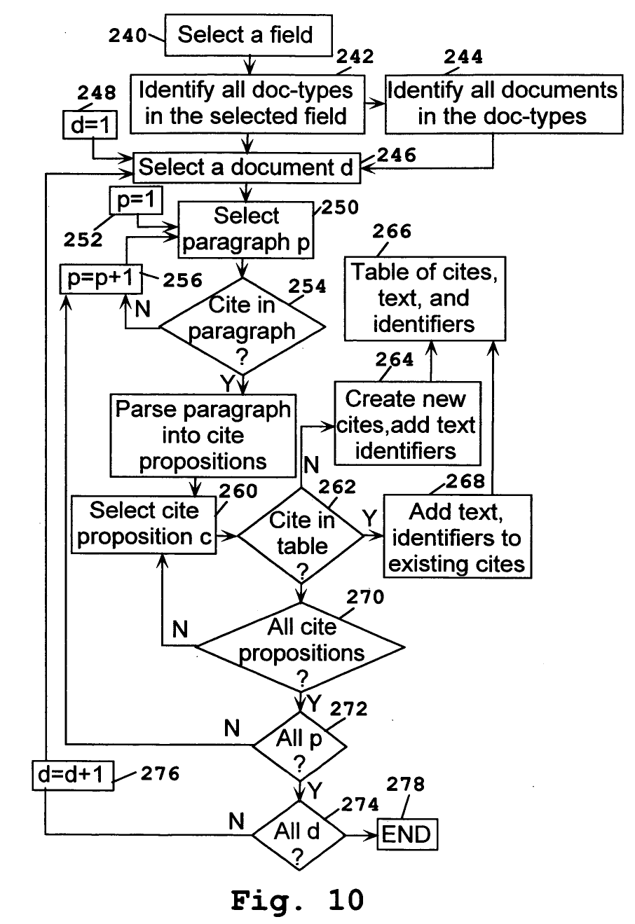

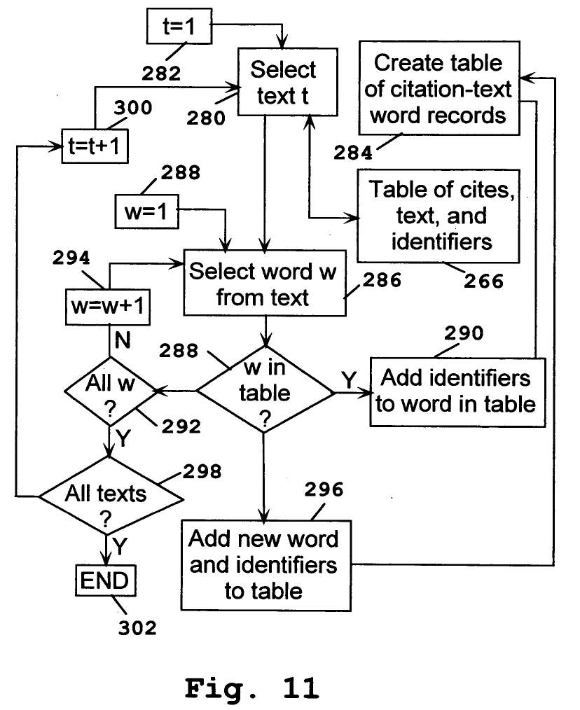

FIG. 10 illustrates the operation of the system in mining documents in a specified document type for citation data. The purpose of the operations shown in this figure is to create a citation table in a citation database for a given field, e.g., a given legal field. This table, indicated at 266 in FIGS. 10 and 11, includes citation names (the key locator in the database table), and associated with each citation name, the one or more legal propositions associated with that citation, and the document and paragraph IDs that contain that citation name, along with user and date of creation IDs for that document. The operations described below with respect to FIG. 11 describe the construction of a corresponding word-records table 284 for the citations database.

As a first step in creating the citations table the program selects a field, e.g., a field of law, such as intellectual property, or tort litigation, or contracts. This selection is typically done automatically and comprehensively for each field that has been set up in the system. The program (or optionally, a user) then identifies all document types for that field, e.g., applications, amendments, appeal briefs, and opinions, in the field of intellectual property, at 242, and identifies all documents for the various document types in that field, at 244.

With the document number and paragraph number (DID and PID) initialized to 1 (boxes 248, 252, respectively), the program selects a document d at 246, and a paragraph p at 250. The selected paragraph is processed for the presence of a citation. Where the citation is a legal citation, the text-processing step involves identifying one or preferably more than one text feature characteristic of a legal cite. This feature might be one or more of:
(i) two words in a text fragment separated by a “v.”;
(ii) a text fragment beginning with “In re”
(iii) a state or federal reporter designation, such as “F.2d,” or “USPQ,”;
(iv) a court abbreviation and date in parentheses, such as (Fed Cir. 1999) or (S. Ct. 2004); or
(v) a footnote to text containing any of the above features.
   Where the citation is a bibliographic citation in a journal or book article, the feature might be:
(i) a word (author's last name), followed by a comma, followed by an initial and period, followed by “et al”
(ii) a journal abbreviation (one-to-three abbreviations)
(iii) a volume and page indicator, e.g., (43):225.
(iv) a page number, e.g., “p. 22” or “pp. 234-256”
(v) a footnote to text containing any of the above features

If no citation is identified within a paragraph, the program proceeds to the next paragraph in the document, through the logic of 254, 256. If a citation is found, the paragraph is parsed into cite propositions, at 256. This involves breaking the paragraph into complete sentences, using typical sentence cues, such as a period followed by a new sentence beginning with a capital letter. The sentence that immediately precedes the citation, or includes the citation at its end, is then extracted at 258, to give a complete sentence (the legal proposition) followed by one or more citations. This unit represents the legal proposition and the citation.

A paragraph may contain more than one citation, as identified, for example, by a different citation names. If all of the citations in a paragraph follow a single sentence, each of these citations is identified with that text sentence (legal proposition), and each becomes a separate proposition unit. If a paragraph contains two or more sentences followed by citation names, each sentence becomes a separate legal proposition. In some case, a single sentence may contain two legal propositions, each followed by citation information, in which case that sentence is parsed into two separate legal propositions.

After this parsing operation, the program selects (box 260) a proposition and a single associated cite(s). If the selected citation is already contained in a table of cites 266, the program adds the additional legal proposition to the cite at 268, along with identifier information related to the cite, including document ID, paragraph ID, user ID, and document preparation or archiving dates. If the selected citation is not already in the citation table, the new citation name is added to the table, at 264, along with the associated proposition and above identifiers.

This procedure is repeated, through the logic of 270, for each citation name from paragraph p. Whether the paragraph contains a single proposition with multiple citations, or multiple legal propositions, each with one or more citations, each citation name and associated proposition is added as a separate entry to the table. Each paragraph is processed in this way, though the logic of 272, 256, then each document d, through the logic of 274 276.

When all documents have been so processed, at 278, the resulting citation name table includes, for each citation name in all of the documents, every legal proposition (preceding sentence) associated with that cite, and all text, paragraph, user, and date identifiers associated with that particular legal proposition (sentence). The legal proposition itself is assigned a separate text identifier that identifies that particular proposition within a particular citation name. That is, each citation name in the table includes at least one, and usually several legal propositions, each corresponding to a separate text, where some of the legal propositions may be identically worded, or nearly identically worded, to the extent they represent the same legal proposition, and some of the propositions within a given cite may be dissimilar in wording, indicating that they represent different legal propositions found in the same citation.

The citation name table 266 is now used to create a citation word-records table 284 in the citation database, according to the operation of the data mining system illustrated in FIG. 11. This table will include all words (the key locators) contained in the citation-table legal propositions, and will be used to identify case citations according to a legal proposition contained in a search query, much as the word-records table in a library database is used to identify text paragraphs containing those words.

With reference to FIG. 11, the program is initialized to text t=1, at 282, and text t is selected at 280 from the list of all legal propositions (individual texts) contained in table 266. With word w initialized to 1, the program then selects word w from text t, at 286, then asks: Is this word in the word-records table 284. If it is, the program adds, at 290, identifiers such as citation name, DID, PID, and UID to that word in table 284. If word w is not already in the table, it is added, at 296, as a new word to table 294, along with the same citation and text identifiers. The program then proceeds to the next word in the text, through the logic of 292, until information and identifiers for all words in text t have been added to table 266. This process is repeated for all texts (the sentences representing legal propositions) in table 266, through the logic of 298, 300. The process terminates at 302, and the completed table 284 contains, for each word in each of the legal proposition in table 266, citation names and text identifiers associated with each instance of that word.

Although not shown here, the program may execute additional data mining operations to extract information from the citation database. For example, the citations can be clustered to identify citation names that tend to cluster within documents. This can be done by assigning a document correlation frequency between each pair of citations in the database, and clustering those citation names which have high internal document correlation frequencies.

Another type of mining that can be carried out is to correlate citation names with dates of document creation, so that the number or frequency of citation of a particular case can be tracked as a function of time. This information can be used, for example, to provide users with the most up-to-date citations for a given legal proposition. Or a particular user might be alerted to more recent citations that the user might wish to employ when preparing new documents.

G. Search Operations in Document-Type Databases

Section E described a search module and search operations for identifying text material of interest within a document-library database. This section describes a search module and search operations that are carried out in document type databases. As noted with reference to FIG. 1, the document-type databases and search module for them are preferably stored and executed on a central server, and are accessible to all users of the system.

The search module allows a user to search in any of four modes: (i) a citation mode, for finding citations names or user names associated with a given legal proposition; (ii) an expertise mode, for finding user names associated with one or more legal propositions and/or citation names; (iii) a paragraph mode, for finding one or more document paragraphs containing one or more search queries, which may be case names, legal proposition, or other description of the contents of a paragraph of interest; and (iv) a document mode for finding a document containing each of a plurality of different queries.

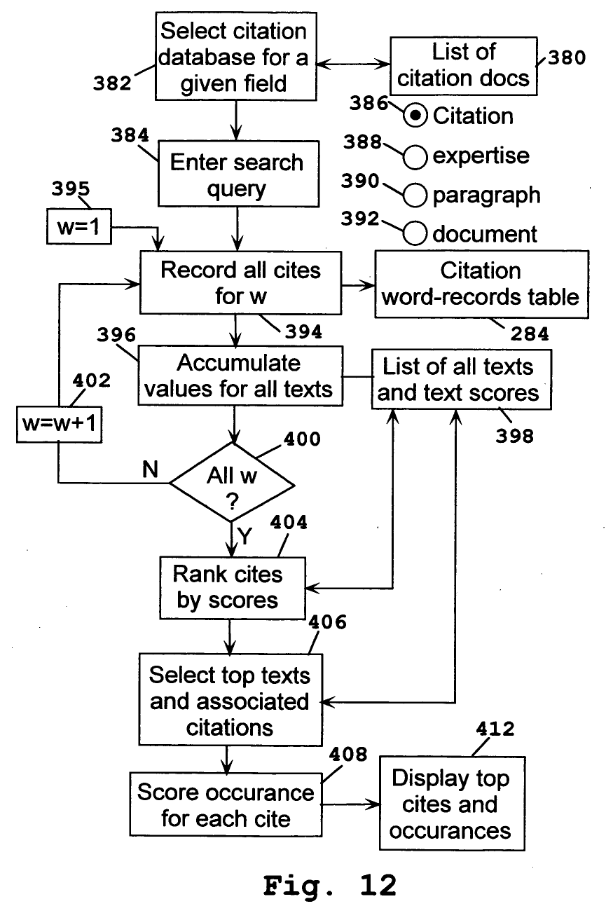

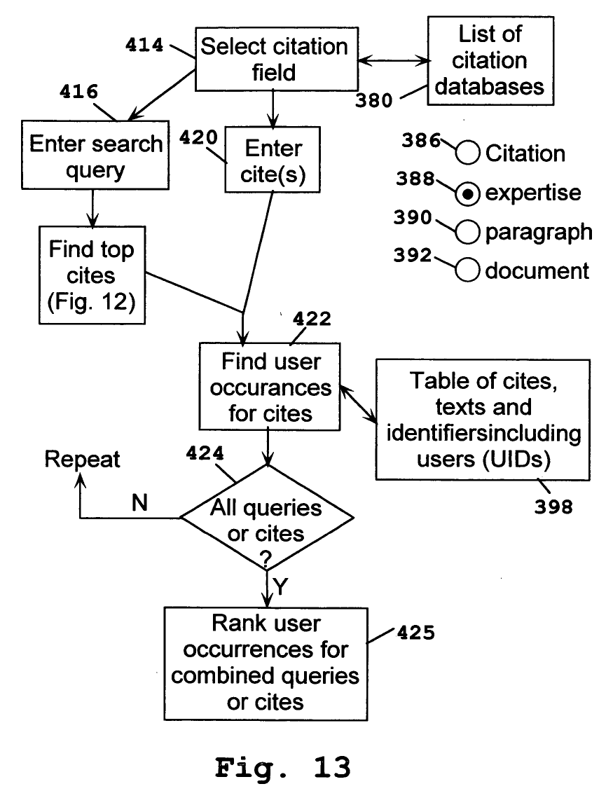

FIG. 12 is a flow diagram of steps carried out in the citation mode. Here the user initially selects at 382, a citation database for a given field, e.g., field of law from a list of citation databases at 380. This is done by selecting radial button 386, out of the four possible choices citation 386, expertise 388, paragraph 390 and document 392. The user then enters a search query which typically is a statement of the legal proposition to be searched, or a list of words associated with such a statement.

With the query words w initialized to 1, at 395, the program selects word w at 394, and accesses the citation word-records table 284 to find all legal propositions (extracted sentences which state a legal proposition) containing that word, and the corresponding citation name. The text identifier and text score, e.g., the value of the coefficient of word w, is then placed in a list 398 of texts and scores, along with the citation name. This process is repeated, through the logic of 400 and 402, until all words in the query have been so processed. It will be appreciated that the process of accumulating values for all text names, at 396, follows the method described above with respect to FIGS. 7A and 8, where the information added to list 398 at each cycle of operation is either additional identifiers to a text name that has already been entered in the list, or new text name and associated identifiers for a text name not yet in the list.

When all words w have been considered, the program computes the match score for each text in list 398, then ranks the scores at 404, and selects the top texts, e.g., texts whose query-match scores are in the top 20% of all scores for the search. The program now counts the citation names from these top texts, at 406, to find an occurrence value for each citation in the top-ranked group of texts, and this information is displayed at 412 to the user, e.g., as a list of citations, each with the number of times that cite is associated with one of the top-ranked texts. The user is thus provided with a list of citations corresponding to the legal-proposition query, where the “rankings” of the different citations can be determined from the number of times the cite is associated with the query.

FIG. 13 is a flow diagram of operations performed by the system when an “expertise” search is selected, as a 388. The purpose of this search mode is to allow the searcher to identify people within the system that have expertise in various aspects of the law, as evidenced by the citations these users have employed in their legal documents.

In this search, the user also selects a given field, at 414, to access a field-specific citation database at 380. The query for this type of search may be either is either the text of a statement representing a legal proposition, as at 416, or a citation name, as at 420 and typically includes more than one query statement and/or citation. If the query includes a statement or statements of legal proposition, the program will “convert” this statement(s) to one or more legal citations, at 418, following the algorithm described for the citation search with respect to FIG. 12.

By consulting the table of citation names 266 in the citation database, at 422, the program identifies all users associated with a given citation, and saves this user name information at 422. The program then repeats these steps for each citation from the query, through the logic of 424, until all citation names have been considered. The users are then ranked by the total number of occurrences for the combined citation queries, at 425, and this information is displayed to the user. The displayed information may include a user number occurrence for each query from which the searcher can then identify at a glance the users that are associated with each legal propositions.

It will be appreciated that citation names serve as a shorthand for legal propositions in this search, and allow users to be identified on the basis of this shorthand, rather than on the basis of natural-language statements whose identification tends to be relatively imprecise. Further, by including a number of different citations that represent various aspects of a legal problem of interest, the searcher can identify those users who have dealt with most or all aspects of the problem of interest.

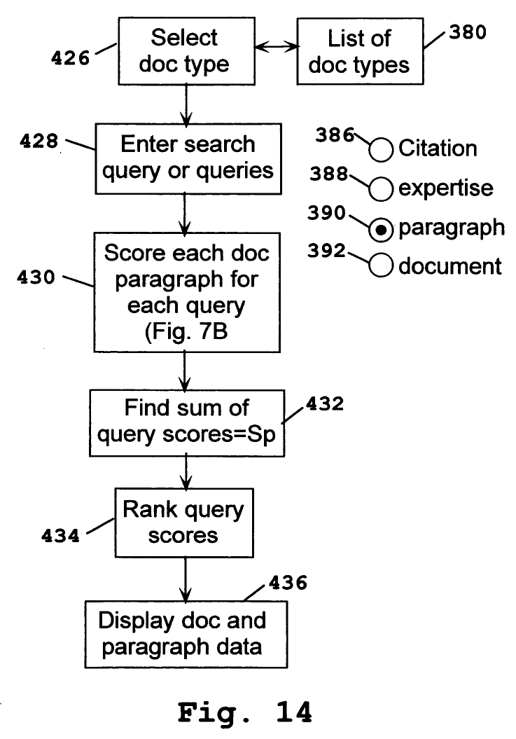

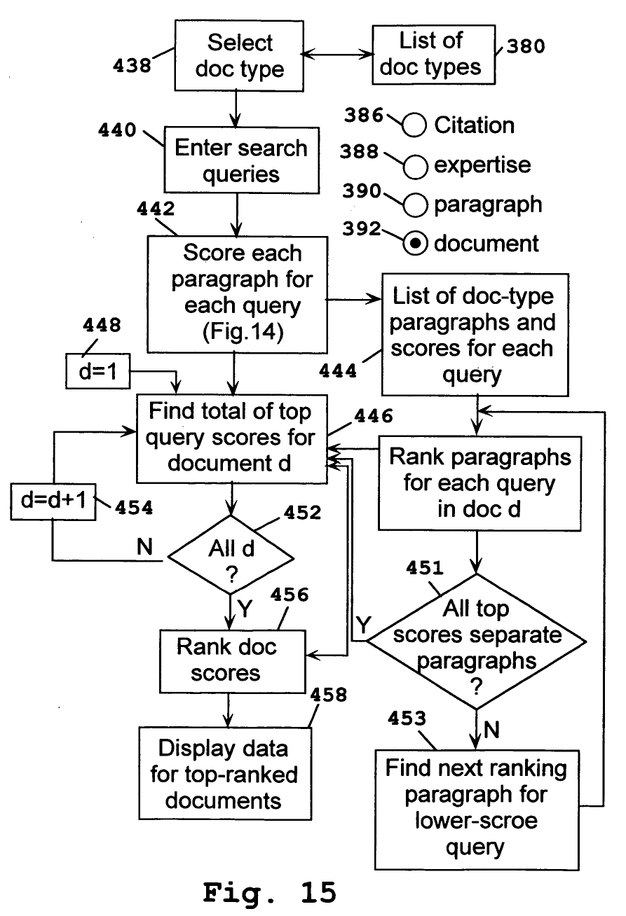

FIG. 14 is a flow diagram of the operation of the system in carrying out a paragraph search. The purpose of this search is to locate, within some defined group of documents (within a selected document type), single paragraphs that give the best word-match with a query.

In carrying out this type of search, the user selects a document type, at 426, from among a list of document types 380, then enters a search query at 428. The query may be a summary of a concept or idea to be search, a legal proposition, a list of words, and/or one or more citations. That is, the query may include a single query or multiple queries one wishes to find within a single document paragraph.

The program scores each paragraph in the document-type database for each query, essentially according to the scoring algorithm described with respect to FIG. 7B. That is, the program accesses the database word-records file to identify, for each word in a query, the text IDs for each word, scores the paragraphs according to a sum of word coefficients, as indicated at 430. Note that a citation name is considered to be a word in this type of search, since the word-records table will include citation names as separate words. This process is repeated for each query. The sum of the individual query scores for all paragraphs is then determined, at 432, and the paragraphs are ranked according to these summed scores, at 434. The output displayed to the user includes paragraph information, including ranking, document and paragraph identifiers, date the document was created, and the text itself. It will be appreciated that some of this data is available directly from the word-records table (document and paragraph IDs), some of it is retrieved from the corresponding text-information table (actual text of the paragraph), and some of is retrieved from a separate document ID table, including document creator and date of document creation.

FIG. 15 is a flow diagram of steps carried out by the system in a document search. The purpose of this search is to locate a document within a selected document type that has a high match score, typically with respect to a plurality of queries, which may be concepts, legal statements, word lists or citations. For example, if the user is looking for a document that deals with a particular legal issue, involves a particular set of facts, is likely to cite one or more known appellate cases, and reaches a desired solution, the user might represent each of these four notions by four different queries. The purpose of the search, then, is to locate a document that contains each of these notions.

Initially, the user selects the document search 392, and a given document type at 438 from a list of document types 380. The user enters one or more queries in a query box 440. The program then scores each paragraph in the document type for each of the separate paragraphs, as described for the paragraph scoring in FIG. 14, to generate a list of all paragraphs and corresponding match scores for each query, at 444. That is, the list at 444 includes a TID designating each paragraph in the document type database, and for each paragraph, separate scores for each of the n queries.

In the next step, shown at 450, the program ranks the paragraphs for each query in each document d considered in the search, to yield, for each query and each document, the top-ranked paragraph for that query. Thus, if there are n queries in the search, the ranking would identify n (or fewer) paragraphs in each document, each paragraph representing the top score for one of the n queries in the search (some paragraphs may represent the top score for more than one query). Assuming it is desired to find n separate paragraphs, each with high match score to one of the n queries, the program will execute the steps indicated at 451 and 453. The first of these asks if all of the top-ranked query scores are in separate paragraphs. If they are, the program finds the total of the top-ranked query scores for each document, at 446. If a single paragraph contains top-ranked scores for two or more queries, the program assigns that paragraph to the highest-score query, and searches list 444 for the next highest ranking paragraph for the other query or queries, at 453, and repeats this process until each of the n queries has been assigned to one of n different paragraphs. Alternatively, the program may skip the steps at 451 and 453, and simply find the sum of the top query scores, at 444, without regard to whether the top scores are in separate paragraphs in a document.

This scoring procedure is repeated for each document, through the logic of 452, 454, until all documents in the selected document type have been processed. The total document scores are then ranked, at 456, and the results displayed to the user at 458. The display may include, for each of a number of top-ranked document, document name, document creator, date of document creation, and individual query match scores, allowing the user to evaluate the “quality” of a document relative to the search.

While the invention has been described with respect to particular embodiments and applications, it will be appreciated that various changes and modification may be made without departing from the spirit of the invention.

It is claimed:

1. A computer-assisted method for retrieving one or more selected texts from a library of documents, comprising
(a) processing a user-input search query composed of a sentence, sentence fragment or word list containing non-generic words representing the content of the text to be retrieved,
(b) accessing a database containing (1) a word-records table composed of (1a) non-generic words contained in said documents and (1b) for each word in the word-records table, a list of identifiers of texts in said documents containing that word, and (2) a document text table containing texts in said documents and associated text identifiers, to identify those texts in the document library having the highest word-match scores with said search query, based on pre-assigned word-match values for the non-generic words in said query,
(c) displaying to the user,
(i) the non-generic words in said query, and
(ii) for each of said non-generic words,
(iia) an occurrence value related to the occurrence of that word relative to other words in the query among texts having the highest word-match scores with the search query, and
(iib) user choices for adjusting the word-match values of each of the non-generic words in the search query, relative to other words in the query,
(d) processing user choices made in response to the information displayed in step (c)(ii),
(e) accessing said table of word records to identify texts in the document library having the highest word-match scores based on the user-adjusted word-match values processed in step (d),
(f) accessing said document text table to retrieve those texts identified in (e), and
(g) displaying to the user one or more of the texts in (e).

2. The method of claim 1, wherein said texts are paragraphs from a plurality of documents, and the text identifiers in the word-records table include document identifiers and paragraph identifiers for each document.

3. The method of claim 1, wherein some of the texts in a document are document titles, said query includes a specified document title and a length value which specifies a given length of document text following said title in a document, and said accessing is performed so as to identify those texts in the database having the highest word-match scores with said search query which are also within the specified document length following the specified document title.

4. The method of claim 1, wherein said length value specifies a given number of paragraphs following the specified title in a document.

5. The method of the section 1, wherein step (c) further includes displaying to the user, texts having the highest word-match scores based on pre-assigned word-match values for the non-generic words in said query.

6. The method of claim 1, wherein the pre-assigned word-match values for the non-generic words in said query are all set to substantially the same number.

7. The method of claim 1, wherein the user choices displayed in step (c)(iib) are (1) discard, (2) leave unchanged, (3) emphasis and (4) require, and each choice is associated with an assigned word-weight value that.

8. The method of claim 1, wherein the summary description of the content of a passage is represented as a description in natural-language passage, and step (a) includes classifying words in the summary description as either (i) generic, (ii) verb-root, or (iii) remaining words that are neither (i) nor (ii), discarding generic words, and converting verb-root words to a common verb root, and verb-root words in the dictionary of word records are expressed in verb-root form.

9. An automated system for retrieving one or more selected texts from a library of documents, comprising
(a) a computer,
(b) accessible by said computer, a database containing (1) a word records table composed of (1a) non-generic words contained in said documents and (1b) for each word in the table, a list of identifiers of texts in the documents containing that word, and (2) a document text table containing texts in said documents and associated text identifiers, and
(c) a computer readable code which is operable, under the control of said computer, to perform the steps of claim 1.

10. Computer-readable code for use with an electronic computer and a database containing (1) a word records table composed of (1a) non-generic words contained in said documents and (1b) for each word in the table, a list of identifiers of texts in the documents containing that word, and (2) a document text table containing texts in said documents and associated text identifiers, wherein said code is operable, under the control of said computer, and by accessing said database and dictionary, to perform the steps of claim 1.

11. A computer-assisted method for retrieving one or more selected texts from a library of documents, comprising
(a) processing a user-input search query composed of a sentence, sentence fragment or word list containing non-generic words representing the content of the text to be retrieved, and a specified document title and length value which specifies a given length of text following said title in a document,
(b) accessing a database containing (1) a word records table composed of (1a) non-generic words contained in said documents and (1b) for each word in the table, a list of identifiers of texts in said documents containing that word, and (2) a document text table containing texts in said documents and associated text identifiers, to identify those texts in the database having the highest word-match scores with said search query, based on pre-assigned word-match values for the non-generic words in said query, and which are within the specified length value following the specified title in said documents, and
(c) displaying to the user one or more of the texts identified in (b).

12. The method of claim 11, wherein said length value specifies a given number of paragraphs following the specified title in a document.

13. A computer-assisted method for retrieving one or more selected texts from a library of documents, where some of said texts may include titles, comprising
(a) processing a user-input search query composed of a sentence, sentence fragment or word list containing non-generic words representing the content of the text to be retrieved, where said query includes a specified title in a document and a length value which specifies a given length of document text following said title in a document,
(b) accessing a database containing (1) a word-records table composed of (1a) non-generic words contained in said documents and (1b) for each word in the word-records table, a list of identifiers of texts in said documents containing that word, and (2) a document text table containing texts in said documents and associated text identifiers, wherein some of the texts in a document are document titles,
(c) by said accessing, identifying those texts in the database having the highest word-match scores with said search query which are also within the specified document length following the specified document title,
(d) accessing said document text table to retrieve those texts identified in (c), and
(e) displaying to the user one or more of the texts in (e).

14. The method of claim 13, wherein said length value specifies a given number of paragraphs following the specified title in a document.
